(19) United States
(12) Patent Application Publication
(10) Pub. No.: US 2015/0036621 A1
(43) Pub. Date: Feb. 5, 2015

(54) METHOD FOR PROVIDING INTERFERENCE INFORMATION IN MOBILE COMMUNICATION SYSTEM

(71) Applicant: Electronics and Telecommunications Research Institute, Daejeon (KR)

(72) Inventor: Joon Woo SHIN, Daejeon (KR)

(21) Appl. No.: 14/445,655

(22) Filed: Jul. 29, 2014

(30) Foreign Application Priority Data
Jul. 31, 2013 (KR) 10-2013-0091041
Jul. 28, 2014 (KR) 10-2014-0095956

(51) Int. Cl. H04L 5/00; H04W 72/04

(52) U.S. Cl. CPC H04L 5/0048; H04L 5/0032; H04W 72/042
USPC 370/329

(57) ABSTRACT

Disclosed are methods for providing interference information in mobile communication systems. The method for providing interference information performed in a base station comprise obtaining information about at least one intra-cell interference signal interfering desired signals of a victim terminal, and transferring the information about at least one intra-cell interference signal to the victim terminal. In the method, the information about at least one intra-cell interference signal may include either information related to generation of reference signal for the at least one intra-cell interference signal or frequency resource allocation information and precoding matrix indicator (PMI) allocation information for the at least one intra-cell interference signal. Thus, the victim terminal may operate an advanced receiver based on the received information thereby canceling interferences efficiently.

### CLAIM FOR PRIORITY

This application claims priorities to Korean Patent Applications No. 10-2013-0091041 filed on Jul. 31, 2013 and No. 10-2014-0095956 filed on Jul. 28, 2014 in the Korean Intellectual Property Office (KIPO), the entire contents of which are hereby incorporated by reference.

### BACKGROUND

1. Technical Field

Example embodiments of the present invention relate in general to an interference cancellation technology for mobile communication systems, and more specifically, to a method for providing interference information needed for cancelling interferences in mobile communication systems.

2. Related Art

The scenarios in which network coordination-based interference cancellation or suppression techniques can be applied to mobile communication systems may be generally classified into two types.

The one is a scenario in which a base station cancels or suppresses inter-user interferences within a single cell in a Multi-User Multiple-Input Multiple-Output (MU-MIMO) environment. Also, the other one is a scenario in which interferences experienced by a user terminal located in a cell-edge region are cancelled or suppressed in a multi-cell environment.

The advanced receiver may be a receiver which adopts network coordination-based interference cancellation and suppression techniques being studied in a 3rd Generation Partnership Project (3GPP) Long Term Evolution-Advanced (LTE-Advanced) standardization. The advanced receiver may use reception methods which can cancel or suppress intra-cell interferences and inter-cell interferences.

In order for a terminal which experiences interferences (a victim terminal) to cancel or suppress the interferences, the victim terminal should know information on the interfering signals, channels related to the interfering signals, and synchronization information exactly.

However, any detailed methods for transferring the interference related information needed for the victim terminal to operate the advanced receiver have not been proposed until now.

That is, in the current LTE or LTE-Advanced system, since each user terminal decodes only a Physical Downlink Control Channel (PDCCH) or an Enhanced PDCCH (E-PDCCH) assigned to itself, there are not any methods for identifying information about interference signals from other terminals or other cells.

Therefore, methods for transferring control information about interference signals as well as control information about desired signals are demanded in order for the victim terminal to operate the advanced receiver thereby cancelling the interference signals.

### SUMMARY

Accordingly, example embodiments of the present invention are provided to substantially obviate one or more problems due to limitations and disadvantages of the related art.

Example embodiments of the present invention provide methods for transferring interference information to a victim terminal in order to make the victim terminal cancel intra-cell interferences and inter-cell interferences.

In some example embodiments, a method for providing interference information, performed in a base station, the method may comprise obtaining information about at least one intra-cell interference signal interfering desired signals of a victim terminal; and transferring the information about at least one intra-cell interference signal to the victim terminal, wherein the information about at least one intra-cell interference signal includes either information related to generation of reference signal for the at least one intra-cell interference signal or frequency resource allocation information and precoding matrix indicator (PMI) allocation information for the at least one intra-cell interference signal.

Here, in the transferring the information about at least one intra-cell interference signal, when the at least one intra-cell interference signal is transmitted based on demodulation reference signal (DM-RS), the information about at least one intra-cell interference signal may include information related to generation of DM-RS, and the information related to generation of DM-RS may be transmitted by using at least one value indicating at least one of combinations of antenna ports and scrambling identities which are used for generating the DM-RS of the at least one intra-cell interference signal. Also, the combinations of antenna ports and scrambling identities may include combinations of scrambling identities and antenna ports 7 and 8.

Here, in the transferring the information about at least one intra-cell interference signal, when the at least one intra-cell interference signal is transmitted based on cell-specific reference signal (CRS), the information about intra-cell interference signals may include frequency resource allocation information and PMI allocation information for all intra-cell interference signals detected within a cell of the base station.

Here, in the transferring the information about at least one intra-cell interference signal, when the at least one intra-cell interference signal is transmitted based on cell-specific reference signal (CRS), the information about intra-cell interference signals may include frequency resource allocation information and PMI allocation information for at least one dominant intra-interference signal selected among a plurality of multiple intra-cell interference signals according to predefined criteria. Also, the frequency resource allocation information and PMI allocation information may be transmitted to the victim terminal separately for each of the at least one dominant intra-interference signal, or transmitted to the victim terminal as an interference information map including frequency resource allocation information and PMI allocation information for the at least one dominant intra-interference signal. Also, the interference information map may comprise information on at least one sub-band allocated to each of the at least one dominant intra-interference signal and a PMI allocated to the at least one sub-band.

Here, in the transferring the information about at least one intra-cell interference signal, the information about at least one intra-cell interference signal may be transferred to the victim terminal as included in a single downlink control information (DCI) with information about the desired signals of the victim terminal, or be transferred to the victim terminal as a DCI separated from a DCI for the information about the desired signals of the victim terminal.

In other example embodiments, a method for providing interference information, performed in a base station, the method may comprise obtaining information about at least one inter-cell interference signal interfering desired signals of a victim terminal; and transferring the information about at least one inter-cell interference signal to the victim terminal, wherein the information about at least one inter-cell interference signal includes at least one of information on generation of reference signal for the at least one inter-cell interference signal, resource allocation information of the reference signal, and resource allocation information of the at least one inter-cell interference signal.

Here, the information about at least one inter-cell interference signal may be obtained from at least one other base station via at least one backhaul link.

Here, when the reference signal for the at least one inter-cell interference signal is a demodulation reference signal (DM-RS), the information on generation of reference signal may include at least one of antenna port information, slot number information, scrambling identity information, virtual cell identity information, and radio network temporary identifier information for the at least one inter-cell interference signal. Otherwise, when the reference signal for the at least one inter-cell interference signal is a cell-specific reference signal (CRS), the information on generation of reference signal may include at least one of cell identity information, cyclic prefix length information, and slot number information for the at least one inter-cell interference signal. Also, the slot number information may be transmitted as a parameter corresponding to the slot number.

Here, the resource allocation information of the reference signal may include at least one of mapping pattern information and frequency shift information for the at least one inter-cell interference signal when the reference signal is a DM-RS, and the resource allocation information of the reference signal may include at least one of antenna port information and cell identity information for the at least one inter-cell interference signal when the reference signal is a CRS.

Here, in the transferring the information about at least one inter-cell interference signal to the victim terminal, the information on generation of reference signal for only at least one inter-cell interference signal interfering a frequency resource block allocated to the victim terminal and resource allocation information of the reference signal may be transferred to the victim terminal.

Here, in the transferring the information about at least one inter-cell interference signal to the victim terminal, when an antenna port 5 is applied to the at least one inter-cell interference signal, cell identity information and cyclic prefix length information for the at least one inter-cell interference signal may be transferred to the victim terminal.

Here, in the transferring the information about at least one inter-cell interference signal to the victim terminal, when at least one of antenna ports 7 to 14 is applied to the at least one inter-cell interference signal, antenna port information, scrambling identity information, cell identity information, and slot number information for the at least one inter-cell interference signal may be transferred to the victim terminal. Also, combinations of antenna ports or combinations of antenna ports and scrambling identities may be configured, and at least one value indicating at least one of the combinations corresponding to the at least one inter-cell interference signal may be transmitted to the victim terminal. Also, the combinations of antenna ports and scrambling identities may be configured as a specific number of combinations in consideration of DM-RS mapping patterns according to antenna ports, each of the combinations having a corresponding indication value, and at least one indication value corresponding to DM-RS mapping pattern of the at least one inter-cell interference signal may be transmitted to the victim terminal.

Also, when the at least one inter-cell interference signal is transmitted based on CRS, the information about at least one inter-cell interference signal may include CRS generation information, CRS resource allocation information, PMI allocation information, and resource allocation information for the at least one inter-cell interference signal.

Also, when the at least one inter-cell interference signal is transmitted based on CRS, the information about at least one inter-cell interference signal may include at least one parameter value corresponding to at least one antenna port for the at least one inter-cell interference signal.

According to the above-described methods for transferring interference information in a mobile communication system, information on intra-cell interference signals and inter-cell interference signals may be transmitted to a victim terminal, whereby an advanced receiver of the victim terminal can efficiently cancel the interference signals based on the information in a multi-cell environment.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram to illustrate an example of intra-interferences in an Orthogonal Frequency Division Multiple Access (OFDMA) system;

FIG. 2 illustrates a DM-RS resource mapping for antenna ports 7 and 8;

FIG. 3 illustrates an example of precoding matrix index map configuration;

FIG. 4 is a conceptual diagram illustrating an example of inter-cell interferences in an OFDMA system;

FIGS. 5A and 5B illustrate DM-RS resource mapping for antenna ports 7 to 14; and

FIG. 6 is a conceptual diagram to explain DM-RS mapping combinations.

### DESCRIPTION OF EXAMPLE EMBODIMENTS

Example embodiments of the present invention are described below in sufficient detail to enable those of ordinary skill in the art to embody and practice the present invention. It is important to understand that the present invention may be embodied in many alternate forms and should not be construed as limited to the example embodiments set forth herein.

Accordingly, while the invention can be modified in various ways and take on various alternative forms, specific embodiments thereof are shown in the drawings and described in detail below as examples. There is no intent to limit the invention to the particular forms disclosed. On the contrary, the invention is to cover all modifications, equivalents, and alternatives falling within the spirit and scope of the appended claims.

The terminology used herein to describe embodiments of the invention is not intended to limit the scope of the invention. The articles “a,” “an,” and “the” are singular in that they have a single referent, however the use of the singular form in the present document should not preclude the presence of more than one referent. In other words, elements of the invention referred to in the singular may number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art to which this invention belongs. It will be further understood that terms in common usage should also be interpreted as is customary in the relevant art and not in an idealized or overly formal sense unless expressly so defined herein.

The term “terminal” used in this specification may be referred to as User Equipment (UE), a User Terminal (UT), a wireless terminal, an Access Terminal (AT), a Subscriber Unit (SU), a Subscriber Station (SS), a wireless device, a wireless communication device, a Wireless Transmit/Receive Unit (WTRU), a mobile node, a mobile, or other words. The terminal may be a cellular phone, a smart phone having a wireless communication function, a Personal Digital Assistant (PDA) having a wireless communication function, a wireless modem, a portable computer having a wireless communication function, a photographing device such as a digital camera having a wireless communication function, a gaming device having a wireless communication function, a music storing and playing appliance having a wireless communication function, an Internet home appliance capable of wireless Internet access and browsing, or also a portable unit or terminal having a combination of such functions. However, the terminal is not limited to the above-mentioned units.

Also, the term “base station” used in this specification means a fixed point that communicates with terminals, and may be referred to as another word, such as Node-B, eNode-B, a base transceiver system (BTS), an access point, etc. Also, the term “base station” means a controlling apparatus which controls at least one cell. In a real wireless communication system, a base station may be connected to and controls a plurality of cells physically, in this case, the base station may be regarded to comprise a plurality of logical base stations. That is, parameters configured to each cell are assigned by the corresponding base station.

Hereinafter, embodiments of the present invention will be described in detail with reference to the appended drawings. In the following description, for easy understanding, like numbers refer to like elements throughout the description of the figures, and the same elements will not be described further.

Hereinafter, interference cancellation methods according to example embodiments of the present invention will be explained by focusing upon an interference rejection combining (IRC) receiver which is an advanced receiver. However, technical thoughts of the present invention are not restricted to an IRC receiver, and may be applied to various types of receivers performing interference cancellation functions.

First, environment and signal models of mobile communication systems, to which the advanced receiver is applied, will be explained.

In case that intra-cell interference signals and inter-cell interference signals coexist in signals received at the receiver, the received signals may be modeled as represented in the following equation 1.

y^{[m,k]}=H^{[m,k]}P^{[m,k]}s^{[m,k]}+Σ_{j≠k}H^{[m,j]}P^{[m,j]}s^{[m,j]}+Σ_{n≠m}ΣⱼH^{[n,j]}P^{[n,j]}s^{[n,j]}+n^{[m,k]} [Equation 1]

In the equation 1, y[m,k] means a signal received by a k-th terminal located in a m-th cell. Here, m and n mean index of each cell, and k and j mean index of each terminal Also, H means a channel coefficient matrix, and P means a precoding matrix, and s means transmitted signals, and n means noise.

Also, in the right side of the equation 1, the first term means a desired signal, and the second term means intra-interference components, and the third term means inter-interference components, and the last term means noise components.

Meanwhile, signals detected at an IRC receiver of the k-th terminal located in the m-th cell may be defined as the following equation 2.

D^{[m,k]}=P^{[m,k]H}H^{[m,k]H}(H^{[m,k]}P^{[m,k]}P^{[m,k]H}H^{[m,k]H}+Σ_{j≠k}H^{[m,k]}P^{[m,k]}P^{[m,k]H}H^{[m,k]H}+Σ_{n≠m}ΣⱼH^{[n,j]}P^{[n,j]}P^{[n,j]H}H^{[n,j]H}+σₙ²I_{N}_{ᵣₓ})⁻¹ [Equation 2]

In the equation 2, the last term in a parenthesis of the right side means an estimated noise and noise power.

Also, the receiver may estimate a transmitted signal by using the equations 1 and 2 as represented in the following equation 3.

ŝ^{[m,k]}=y^{[m,k]}·D^{[m,k]} [Equation 3]

In the equation 3, g^{[m,k]} means a transmitted signal estimated at the k-th terminal located in the m-th cell.

The detected signal of the IRC receiver represented in the equation 2 may be obtained based on the assumption that the receiver knows information about interference signals as well as information about the desired signals. Here, the receiver may obtain the information about the desired signals (i.e. channel coefficients, precoding matrix information, etc.) from a demodulation reference signal (DM-RS), a cell-specific RS (CRS), and a Physical Downlink Control Channel (PDCCH) according to methods predefined in the existing 3GPP LTE/LTE-Advanced specifications. However, the methods for obtaining the information about interference signals have not been defined yet.

Therefore, the present invention provides methods for transferring the interference signal information needed for the IRC receiver of the k-th terminal located in the m-th cell.

Hereinafter, the methods for transferring the interference signal information needed for operating the IRC receiver will be explained specifically.

The interference signal information needed for implementation of the IRC receiver may include covariance matrix information in which interference channel information and information on a precoding matrix used for transmitting the interference signal are combined. That is, the interference signal information may be the second and third terms included in the parenthesis of the right side in the equation 2.

The interference signals may be classified into intra-cell interference signals which are generated when a multi-user MIMO (MU-MIMO) is performed for user terminals within a cell by using identical time/frequency resources and inter-cell interference signals generated by signals transmitted from adjacent cells. Specifically, the inter-cell interference signals may be generated by a MU-MIMO transmission or a single-user (SU) transmission.

Hereinafter, the methods for transferring information on the intra-cell interferences and the methods for transferring information on the inter-cell interferences will be explained as separated. Also, for the methods for transferring the information on the inter-cell interferences, it is assumed that interference related information is exchanged between neighbor base stations through ideal backhauls having no latency.

Methods for Transferring Information Related to Intra-Cell Interferences

The intra-cell interferences may mean spatial interferences generated between user terminals within a cell, when a MU-MIMO is performed on multiple user terminals by a base station through the identical time/frequency resources.

In the current LTE-Advanced systems, the MU-MIMO is performed based on DM-RS for transmission modes (TM) 7, 8, and 9. Also, the MU-MIMO is performed based on CRS for transmission mode 5.

Hereinafter, the methods for obtaining covariance information about interference signals according to transmission modes will be explained.

(1) Methods for a DM-RS Based Transmission Environment

When a receiver performs channel estimation based on DM-RS, it may obtain effective channel information in which the corresponding channel information and precoding information are combined.

However, in the existing LTE/LTE-Advanced systems, a terminal which receives interferences (hereinafter, referred to as a ‘Victim User Equipment (UE)’ or ‘Victim terminal’) cannot identify information related to DM-RS of the intra-cell interference signals.

In order for the victim terminal to estimate effective channels of the intra-cell interference signals, the victim terminal should identify information related to generation of DM-RS of the interference signals.

According to the current LTE/LTE-Advanced specifications, initialization parameters for generating DM-RS sequences are represented as the following equation 4.

cᵢₙᵢₜ=(└nₛ/2┘+1)(2N_{ID}^{cell}+1)2¹⁶+n_{RNTI} for antenna port 5

cᵢₙᵢₜ=(└nₛ/2┘+1)(2n_{ID}⁽ⁿ^{_{SCID}}⁾+1)2¹⁶+n_{SCID} for antenna port 7˜6+v [Equation 4]

In the equation 4, v means the number of layers. Also, other parameters included in the equation 4 are defined in the LTE/LTE-Advanced specifications.

Thus, in order to the victim terminal to generate DM-RS sequences of the intra-cell interference signals, it should know antenna port number, slot numbers (nₛ), scrambling ID (n_{SCID}), a Radio Network Temporary Identifier (n_{RNTI}), a virtual cell ID (n_{ID}⁽ⁱ⁾) for the intra-cell interference signal. Here, the scrambling ID may be necessary for the antenna ports 7 to 14, and the RNTI may be necessary for the antenna port 5. Also, the virtual cell ID may be necessary for the antenna ports 7 to 14.

According to the current LTE/LTE-A specifications, the antenna port 5 is not applied to MU-MIMO. Thus, since a situation in which the antenna port 5 is used for modeling intra-cell interference signals does not occur, it is not necessary to consider information related to the antenna port 5 for the modeling of intra-cell interference signals.

On the other hand, in cases of the antenna ports 7 to 6+v, information about antenna port number of the interference signal, scrambling ID (n_{SCID}) of the interference signal, and the virtual cell ID should be transferred to the victim terminal. Here, since the virtual cell ID (n_{ID}^{(DMRS,i)}) has the same value with the cell ID (N_{ID}^{cell}) when the corresponding cell is not operating in a coordinate multipoint transmission/reception (CoMP) mode, it is not necessary to transfer the virtual cell ID to the victim terminal for the intra-cell interference environment. However, if the corresponding cell is operating in the CoMP mode, 9 bits information corresponding to the virtual cell ID should be informed to the victim terminal.

Meanwhile, in order to apply appropriate methods to each resource element (RE), the receiver should have frequency resource (block) allocation information of the interference signals.

If the desired signals and the interfering signals are scheduled on the same time/frequency resources, the frequency resource (block) allocation information is not needed to be transferred to the victim terminal.

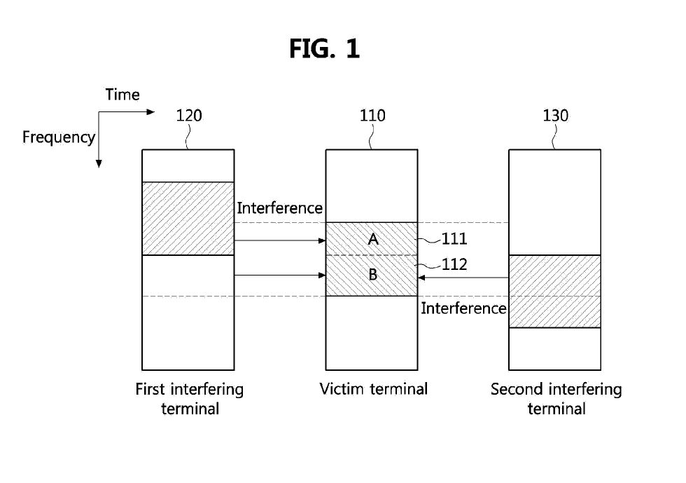

FIG. 1 is a conceptual diagram to illustrate an example of intra-interferences in an Orthogonal Frequency Division Multiple Access (OFDMA) system. In FIG. 1, illustrated is interference relationship between terminals when resources 100 allocated to the victim terminal are co-scheduled with the resources 120 allocated to a first interfering terminal and resources 130 allocated to a second interfering terminal.

As shown in FIG. 1, cases that frequency bands for the victim terminal and interfering terminals are co-scheduled as overlapped with each other may occur.

As illustrated in FIG. 1, interferences caused by signals transmitted by the first interfering terminal may occur in a frequency resource region 111 of the victim terminal, and interferences caused by the second interfering terminal may occur in a frequency resource region 112 of the victim terminal.

Therefore, the IRC receiver of the victim terminal should apply different processing to each of the frequency regions 111 and 112.

In the case of the DM-RS based transmission, if a base station informs the victim terminal of DM-RS related information of interference signals to be co-scheduled, the victim terminal may perform the DM-RS based effective channel estimation for corresponding frequency bands of the interference signals based on the received DM-RS related information. Also, the victim terminal may cancel the interferences by adjusting interference parameters of the IRC receiver based on the estimated information of the effective channels. Here, the values of estimated channels may be close to 0 when the interference signals do not exist, and the values of estimated channels may have values corresponding to the interference signals when the interference signals exist. As described above, since the IRC receiver cancels interferences according to the estimated channels, interference information is applied to the IRC receiver through the estimated channel values when the interferences exist. Otherwise, if the interferences do not exist, the interference information is not applied to the IRC receiver.

Meanwhile, in the methods for obtaining information related to the intra-cell interference signals, it is not necessary to transfer frequency resource (block) allocation information to the victim terminal in case of the DM-RS based transmission.

Hereinafter, methods for notifying DM-RS generation parameters (i.e. scrambling IDs) to the victim terminal by relating them to resource mapping patterns of the DM-RS (or, orthogonal Walsh codes) will be explained.

According to the current LTE-Advanced specifications, only antenna port 7 or 8 is used in a MU-MIMO transmission.

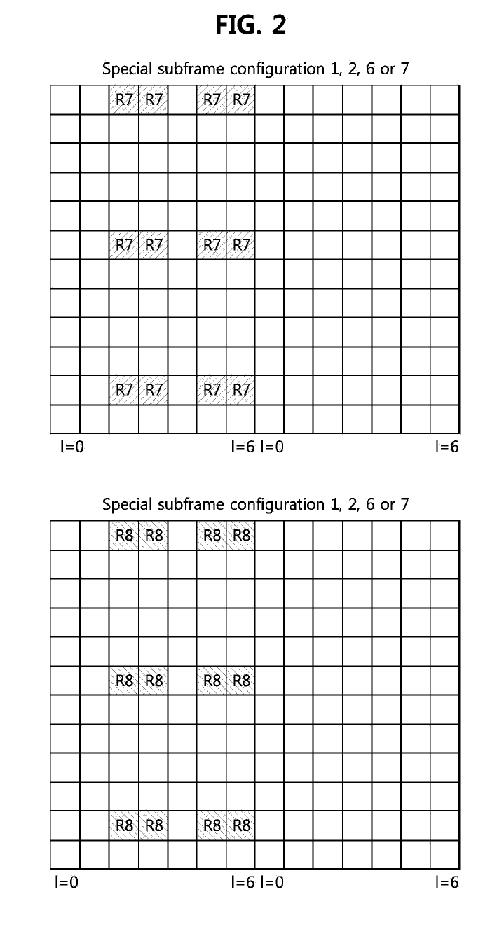

FIG. 2 illustrates a DM-RS resource mapping for antenna ports 7 and 8. In FIG. 2, 1 means a time-domain index.

As illustrated in FIG. 2, a DM-RS can be mapped to a specific subcarrier of a sub frame so as to have orthogonality by using a length-2 Walsh code. Also, four terminals co-scheduled on the same resources can be separated by assigning two DM-RS sequences using different scrambling ID for each Walsh code.

Therefore, the victim terminal may perform channel estimation by separating DM-RS of desired signals from DM-RS of interference signals based on the Walsh codes and the scrambling IDs.

The LTE-Advanced specification defines combinations of antenna ports, the number of layers, and scrambling IDs, and describes a method for explicitly transferring the corresponding information to the victim terminal by using a value indicating one of the combinations.

In the present invention, two methods are provided as methods for transferring information related to intra-cell interferences to the victim terminal in consideration of the combinations defined in the LTE-Advanced specification.

In the first method among two methods, as shown in the below table 1, combinations of antenna port numbers and scrambling IDs of interference signal are configured, and values each of which indicates one of the combinations are defined. The indication value is explicitly transferred to the victim terminal. Here, information on the combinations and the indication values should be commonly shared by terminals and base stations in advance.

The victim terminal may obtain information on an antenna port number and a scrambling ID of the interference signal based on the indication value received from a base station, and estimate a desired channel and an interference channel by using the obtained information.

TABLE 1

| Value | Combination |
|---|---|
| 0 | Port 7, n_{SCID} = 0 |
| 1 | Port 7, n_{SCID} = 1 |
| 2 | Port 8, n_{SCID} = 0 |
| 3 | Port 8, n_{SCID} = 1 |
| 4 | Port 7/8, n_{SCID} = 0 |
| 5 | Port 7/8, n_{SCID} = 1 |

In the table 1, the indication value 4 or 5 is used for cases when the number of layers used for the desired signal is different from the number of layers used for the interference signal. For example, when the desired signal is transmitted by using the antenna port 7 and the scrambling ID 0 (n_{SCID}=0), the interference signal (signal of another terminal co-scheduled with the victim terminal) may be transmitted by using the antenna ports 7 and 8 and the scrambling ID 1 (n_{SCID}=1). That is, while a single layer transmission is performed for the victim terminal, interference signals to which a dual layer transmission is applied may be included in a signal received at the victim terminal. Thus, interference-related information can be provided to the victim terminal by using the above table 1 for the above cases.

In the second method among two methods, a base station may not explicitly transfer an antenna port number and a scrambling ID of the interference signal to a victim terminal. That is, the victim terminal may estimate an effective channel of the interference signal by performing blind tests on a set of antenna ports (i.e. {7, 8}) and a set of scrambling IDs (i.e. {0,1}). In this case, the victim terminal can perform the blind tests on antenna ports by varying Walsh codes, and perform the blind tests on scrambling IDs by varying DM-RS generation. Also, a channel estimation performance or a reception performance to which IRC is applied may be used as criteria for estimating interference signal information.

Among the above two methods, the first method have effectiveness in an aspect of computation complexity of the receiver. However, the first method has a disadvantage of increasing overhead of resources to be used for information transfer. On the contrary, although the second method increases complexity of the receiver, it may have an advantage in an aspect of resource overhead.

In addition, parameters which should be explicitly transferred to the victim terminal among the above-described DM-RS related parameters of the interference signal may be transferred to the victim terminal by defining a new downlink control information (DCI) including a DCI for the desired signal to be transmitted to the victim terminal (i.e. a transmission using a single DCI). Alternatively, a separate DCI including the parameters which should be explicitly transferred to the victim terminal may be transmitted to the victim terminal, in addition to the DCI for the desired signal (i.e. a transmission using multiple DCIs).

(2) Methods for a CRS Based Transmission Environment

Unlike the above DM-RS based channel estimation in which a receiver can estimate an effective channel (i.e. actual channel information and precoding information), a receiver can estimate only channel information in the CRS-based channel estimation.

Accordingly, for the IRC receiver, the victim terminal should have CRS generation information, CRS resource allocation information, frequency resource allocation information of the interference signal, and precoding matrix indicator (PMI) allocation information of the interference signal. Although estimation on an effective channel is possible and so frequency resource allocation information is not necessary in the DM-RS based channel estimation, frequency resource allocation information and PMI allocation information for each interference signal, in the CRS-based channel estimation, should be given to the receiver in order to estimate an effective channel of the interference channel.

In order to generate CRS, initialization parameters for CRS (i.e. cell ID information and cyclic prefix length information) are needed. However, since the above information is cell-specific information shared by all terminals located within a cell, no additional signaling for the above information is necessary. Also, the CRS resource allocation information may not be signaled additionally according to the same reason.

Thus, the base station may transfer only the frequency resource allocation information and PMI allocation information of the interference signal to the victim terminal additionally.

As methods for transferring the frequency resource allocation information and PMI allocation information of the interference signal to the victim terminal, the following two methods can be considered.

The first method among the two methods is that the base station transfers the frequency resource allocation information and PMI allocation information of all detected (or, measured) intra-cell interference signals. In this case, there is an advantage that all information are informed to the victim terminal explicitly and exactly. However, as the number of interfering terminals and amount of PMI allocation information applied to the interfering signals increases (i.e. when different PMI is applied to each sub-band), amount of information to be transferred to the terminal increases, thereby increasing resource overhead.

The second method is a method which can supplement the above-described shortcoming of the first method. In the second method, only frequency resource allocation information and PMI allocation information of one or more interference signals which have dominant effects on the victim terminal among multiple intra-cell interference signals are transferred to the victim terminal. In this case, the base station may select one or more interference signals having dominant effects on the victim terminal according to predefined criteria. For example, the base station may select one or more dominant interference signal based on various criteria such as degrees of redundancy between resources allocated to the desired signals and resources allocated to the interference signals, relative positions between terminals, etc.

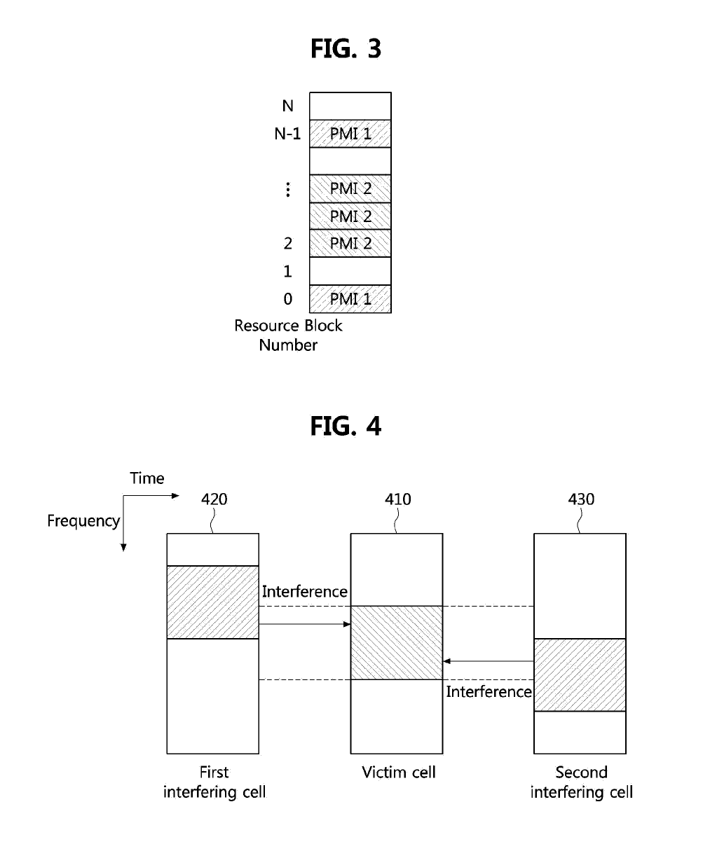

In the second method, the base station may separately transmit the frequency resource allocation information and the PMI allocation information to the victim terminal, or transmit them to the victim terminal by configuring a PMI map as shown in FIG. 3.

FIG. 3 illustrates an example of precoding matrix index map configuration.

As shown in FIG. 3, the base station may configure a map having sub-bands each of which corresponds to a frequency resource allocated to each of the interference signals having dominant effects on the victim terminal, and assign PMI information to each element of the map. In this case, frequency allocation information may be implicitly assigned to the PMI map.

Similarly to the above-described methods for transferring DM-RS related parameters of interference signals, parameters which should be explicitly transferred to the victim terminal among the above-described DM-RS related parameters of the interference signal may be transferred to the victim terminal by defining a new downlink control information (DCI) including a DCI for the desired signal to be transmitted to the victim terminal (i.e. a transmission using a single DCI). Alternatively, a separate DCI including the parameters which should be explicitly transferred to the victim terminal may be transmitted to the victim terminal, in addition to the DCI for the desired signal (i.e. a transmission using multiple DCIs).

Methods for Transferring Information Related to Inter-Cell Interferences

In case of the inter-cell interference signals, most of interference signals may not be signals co-scheduled with signals desired by the victim terminal on the identical time/frequency resources.

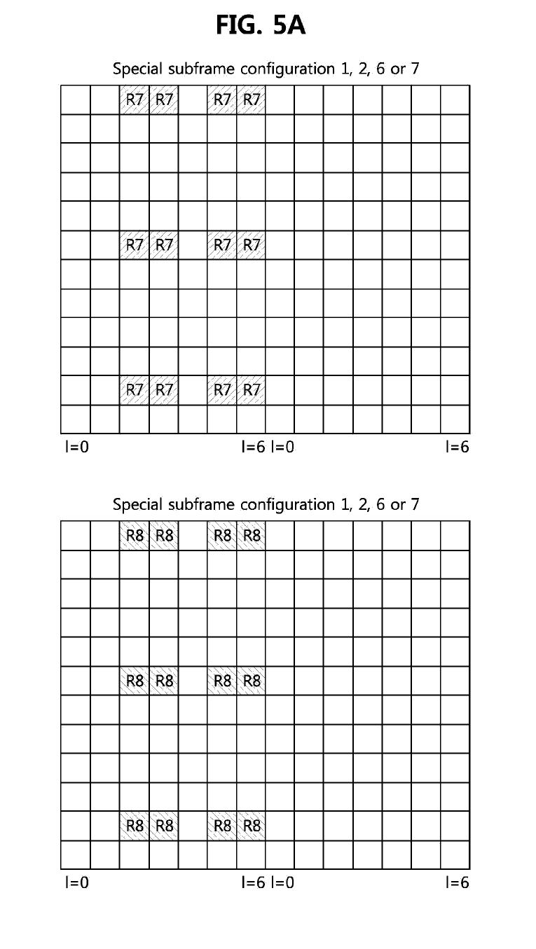

FIG. 4 is a conceptual diagram illustrating an example of inter-cell interferences in an OFDMA system. In FIG. 4, interference relationship between resources 410 allocated to a victim terminal located in a cell and resources 420 and 430 allocated to interference signals from other cells adjacent to the cell of the victim terminal.

As shown in FIG. 4, a portion of frequency resources (i.e. resource blocks) allocated to the victim terminal may be overlapped with resources allocated to interference signals from other cells adjacent to the cell. Here, the inter-cell interference may be generated while performing a SU-MIMO transmission or a MU-MIMO transmission unlike the case of the intra-cell interference.

Base stations managing cells may exchange inter-cell interference related information via backhaul links. Here, the backhaul links may be assumed to be ideal backhaul links without latency and error.

(1) Methods of Estimating Effectives Channel for Other Cells in a DM-RS Based Transmission Environment

In order for the victim terminal to estimate an effective channel of the inter-cell interference signal based on DM-RS, it should have information about generation of DM-RS of the interference signal, DM-RS resource allocation information, and frequency resource allocation information of the interference signal. Here, the DM-RS resource allocation information may include DM-RS pattern information and information on frequency shift according to a cell ID. The frequency shift information may be necessary for only the antenna port 5.

The reason why the victim terminal should know frequency resource allocation of the interference signal is that the IRC receiver of the victim terminal should operate differently according to interference signals giving dominant effects on the victim terminal when the frequency resources allocated to the victim terminal do not coincide with the frequency resources allocated to the interference signals.

According to the LTE-Advanced specification, the frequency resource allocation information may be transferred to a terminal via DCI, and may be configured with at most 12 bits.

Meanwhile, the frequency resource allocation information of the inter-cell interference information may be primarily transmitted via a backhaul link from a base station of a cell giving interference signals (hereinafter, referred to as an ‘interfering cell’) to a base station of a cell to which the victim terminal belongs (hereinafter, referred to as a ‘victim cell’).

As a simple method, a method, in which the base station of the interfering cell transmits the frequency resource allocation information of the inter-cell interference signal to the base station of the victim cell, and the base station of the victim cell transfers the information to the victim terminal, and the victim terminal operates the IRC receiver based on the transferred information, may be considered. However, if the inter-cell interference signals are generated from multiple cells or multiple inter-cell terminals, there may be a shortcoming that overhead of resources needed for transmitting the frequency resource allocation information corresponding to multiple inter-cell interference signals increases significantly.

Thus, in the present invention, when the base station of the victim cell already knows information about interference signals allocated to frequency resources used by the victim terminal, the base station of the victim cell may not explicitly transmit the frequency resource allocation information of interference signals to the victim terminal, and may transmit only DM-RS generation parameters and DM-RS resource allocation information of interference signals interfering frequency resource blocks (RB) allocated to the victim terminal. The above-described method considers that, since the DM-RS based channel estimation can estimate effective channels of interference signals (i.e. channel information and PMI), a large estimated value of a corresponding interference channel gives large effect to the IRC receiver, and a small estimated value of the corresponding interference channel gives small effect to the IRC receiver.

The victim terminal may perform DM-RS based channel estimation on corresponding frequency resources based on inter-cell interference information received from the base station. At this time, the victim terminal may perform channel estimation on desired signals and interference signals, and then apply effective channel information obtained through it to the IRC receiver.

Since the above described method should perform channel estimation on frequency resources which may not have interferences based on assumption that interferences can exist on the frequency resources, it may have a shortcoming of increased amount of computation. However, it may have an advantage of decreased resources to be used for transmitting frequency resource allocation information of interference signals.

Meanwhile, the DM-RS generation related parameters may include information on antenna ports (5, 7 to 14), slot number (nₛ), scrambling ID (n_{SCID}), virtual cell ID (n_{ID}⁽ⁱ⁾), RNTI, etc. Here, the virtual cell ID is necessary for cases using antenna ports 7 to 14, and the RNTI is necessary only for a case using the antenna port 5.

The above DM-RS generation related parameters may be transferred via a backhaul link from the base station of the interfering cell to the base station of the victim cell, and the base station of the victim cell may transmit the information to the victim terminal by using a newly-defined DCI including contents for the desired signal (a single DCI method) or by using an additional DCI (multiple DCI method).

The victim terminal may generate DM-RS of inter-cell interference signals based on the above parameters transferred from the base station.

The slot number may be identified by the terminal through a frame synchronization obtained by using a Primary Synchronization Signal (PSS) and a Secondary Synchronization Signal (SSS) in a cell.

Therefore, in order to transmit information on slot number of inter-cell interference signal to the victim terminal, a method, in which additional signaling parameters (T_{SLOT}) for each slot number are defined as shown in the following table 2 and a parameter indicating a corresponding slot number among the defined parameters is transmitted to the victim terminal, may be used.

TABLE 2

| Slot Number | T_{SLOT} |
|---|---|
| 0 | 00000 |
| 1 | 00001 |
| 2 | 00010 |
| 3 | 00011 |
| 4 | 00100 |
| 5 | 00101 |
| 6 | 00110 |
| 7 | 00111 |
| 8 | 01000 |
| 9 | 01001 |
| 10 | 01010 |
| 11 | 01011 |
| 12 | 01100 |
| 13 | 01101 |
| 14 | 01110 |
| 15 | 01111 |
| 16 | 10000 |
| 17 | 10001 |
| 18 | 10010 |
| 19 | 10011 |

In order for the victim terminal to estimate channels for inter-cell interference signals, DM-RS resource allocation information is needed. When the antenna port 5 is used (since the interference signals are inter-cell interference signals, MU-MIMO operations may not be applied), the interference signal does not have orthogonality according to use of Walsh code unlike other antenna ports, and only a frequency shift based on a cell ID is applied. Here, a form of frequency shift may be differentiated according to the length of cyclic prefix (CP).

Thus, in case of the antenna port 5, if a cell ID of the inter-cell interference signal and CP length information are transferred to the victim terminal, the victim terminal may perform channel estimation on the inter-cell interference signal based on DM-RS. Generally, the identical CP length is assumed for both the victim cell and the interfering cell. If different CP lengths are used for the victim cell and the interfering cell, the application of the IRC receives becomes difficult because frequency bandwidths of resource elements (REs) become different.

Otherwise, in cases of the antenna ports 7 to 14, a frequency shift based on a cell ID does not exist, but an orthogonal Walsh code may be allocated to each antenna port.

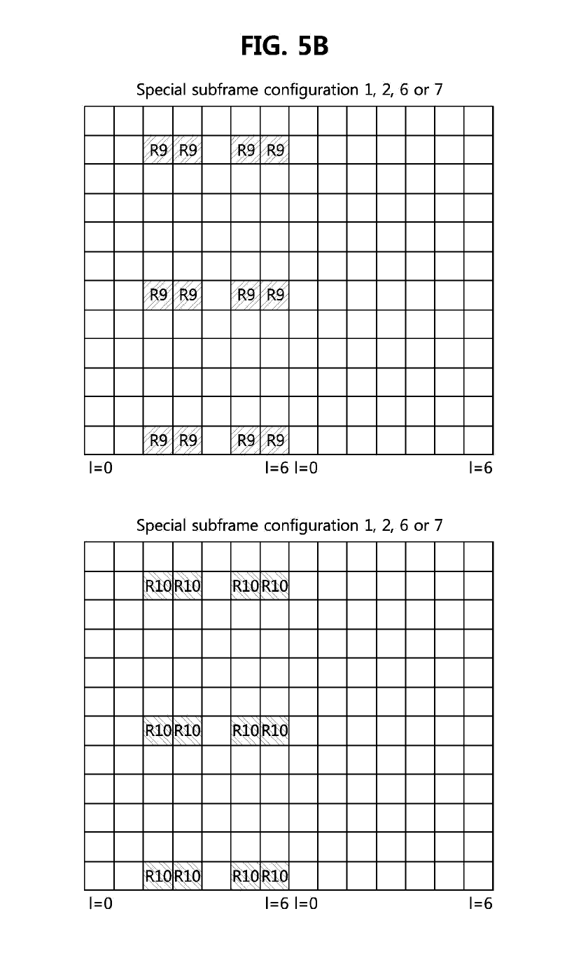

FIGS. 5A and 5B illustrate DM-RS resource mapping for antenna ports 7 to 14. In FIGS. 5A and 5B, 1 means a time-domain index.

As illustrated in FIGS. 5A and 5B, a subcarrier to which DM-RS is mapped may vary according to antenna port number, and a Walsh code allocated to each DM-RS may vary according to antenna port number.

That is, at most four orthogonal Walsh codes may be allocated to a specific subcarrier, and two subcarrier groups may exist. Accordingly, at most eight antenna ports (i.e. antenna ports 7 to 14) may be configured to have orthogonality to each other.

Also, DM-RSs can be separated through a randomization or an orthogonalization according to inter-cell interference condition by applying a virtual cell ID to generation of DM-RS. For example, in case that the same virtual cell ID is used, the orthogonalization may be used. Otherwise, when different virtual cell IDs are used, the randomization may be used.

Also, a scrambling ID 0 or 1 may be allocated to each antenna port and applied to generation of DM-RS sequence whereby effects of the randomization may be enhanced.

If the above descriptions are summarized, the victim terminal may perform channel estimation by separating DM-RS for each layer based on antenna port number, virtual cell ID, and scrambling ID.

Meanwhile, the LTE-Advanced specification defines combinations of antenna port numbers and scrambling IDs, and describes a method for explicitly transferring the corresponding information to the victim terminal by using a value indicating one of the combinations.

In the present invention, provided is a method for transferring information related to inter-cell interferences to the victim terminal in consideration of the combinations defined in the LTE-Advanced specification.

First, methods for a case in which a normal CP is applied (i.e. antenna ports 7 to 14) will be explained.

The first method among the methods is a method for explicitly transmitting antenna port information and scrambling ID information of the inter-cell interference signal to the victim terminal. According to the LTE-Advanced specification, when three to eight transmission layers are used (that is, antenna ports 7 to 9, 7 to 10, 7 to 11, 7 to 12, 7 to 13, or 7 to 14 are used simultaneously), a scrambling ID is fixed to 0, and so information about the scrambling ID is not needed to be transmitted separately. In the present invention, used is a method for configuring indication values indicating combinations of antenna ports and scrambling IDs as shown in the following table 3 and transmitting an indication value corresponding to the inter-cell interference signal. In this case, cell ID information (or, virtual cell ID information) for generation of DM-RS, slot number information, etc. should be transmitted together.

TABLE 3

| Value | Messages |
|---|---|
| 0 | Port 7, n_{SCID} = 0 |
| 1 | Port 7, n_{SCID} = 1 |
| 2 | Port 8, n_{SCID} = 0 |
| 3 | Port 8, n_{SCID} = 1 |
| 4 | Port 7-8, n_{SCID} = 0 |
| 5 | Port 7-8, n_{SCID} = 1 |
| 6 | Port 7-9 |
| 7 | Port 7-10 |
| 8 | Port 7-11 |
| 9 | Port 7-12 |
| 10 | Port 7-13 |
| 11 | Port 7-14 |

In the above-described first method, since the antenna port information is explicitly transmitted to the victim terminal, the victim terminal can identify a DM-RS pattern (or, a Walsh code) for the inter-cell interference signal exactly.

The second method among the methods is a method in which the combinations included in the table 3 are simplified into only two cases as shown in the following table 4 by considering a fact that antenna ports 7 and 8 are used with a higher probability and a fact that subcarriers to which DM-RS of the antenna ports 7 and 8 and subcarriers to which DM-RS of the antenna ports 9 to 14 are different, and an indication value corresponding to the interference signal is transmitted to the victim terminal

TABLE 4

| Value | Messages |
|---|---|
| 0 | Case A (port 7/8) |
| 1 | Case B (ports 7~14) |

In the table 4, a case using the antenna ports 7 and 8 are defined as a case A, and cases using at least three of the antenna ports 7 to 14 are defined as a case B. Then, an indication value 0 is allocated to the case A, and an indication value 1 is allocated to the case B.

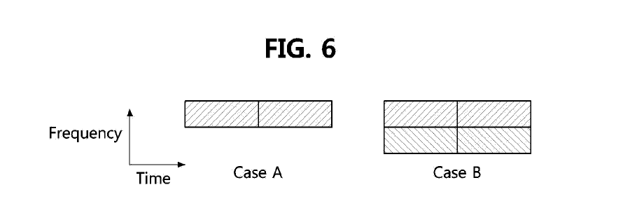

FIG. 6 is a conceptual diagram to explain DM-RS mapping combinations.

In the present invention, the table 4 is configured by considering a fact that DM-RS for the antenna ports 7 and 8 (case A) is mapped to a specific subcarrier and DM-RS of the antenna ports 7 to 14 (case B) is mapped to one of two frequency-contiguous subcarriers, and antenna port number information and scrambling ID information of the inter-cell interference signal is transferred to the victim terminal as simplified by using the table 4.

In the second method among the methods, the base station transmits only an indication value indicating one of the above two cases to the victim terminal. Then, the victim terminal estimates a channel by performing blind tests on a set of DM-RS patterns (or, Walsh codes) and a set of scrambling IDs corresponding to the case indicated by the received indication value.

For example, when the victim terminal identifies that an interference signal corresponding to the case A exists among interference signals, it may be identified that the interference signal corresponds to the antenna ports 7 and 8, and then the victim terminal may estimate a channel by performing blind tests on the combinations corresponding to the indication values 0 to 5 of the table 3. Similarly, when the victim terminal identifies that an interference signal corresponding to the case B exists among interference signals, it may be identified that the interference signal corresponds to the antenna 7 to 9, 7 to 10, 7 to 11, 7 to 12, 7 to 13, or 7 to 14, and then the victim terminal may estimate a channel by performing blind tests on the combinations corresponding to the indication values 6 to 11 of the table 3. Here, in the case B, since the scrambling ID is fixed as 0, the victim terminal does not have to consider blind tests on scrambling IDs. In the second method, cell ID information (or, virtual cell ID information) and slot number information also should be transmitted to the victim terminal explicitly.

The third method among the methods is a method in which antenna port information and scrambling ID information are not explicitly transmitted to the victim terminal and the victim terminal estimates a channel by performing blind tests on all possible combinations of antenna ports and scrambling IDs. Thus, the victim terminal performs all possible combinations shown in the table 3. In the third method, cell ID information (or, virtual cell ID information) and slot number information should also be transmitted to the victim terminal explicitly.

Among the above-described three methods, implementation complexity increases in order of the first method, the second method, and the third method. Amount of information transmitted from a base station to a terminal increases in order of the third method, the second method, and the first method.

For cases using an extended CP, only antenna ports 7 and 8 are used. Thus, the above-described methods for transferring intra-cell interference information may be used as methods for transferring inter-cell interference information for the extended CP cases.

Similarly to the above-described methods, parameters which should be explicitly transferred to the victim terminal may be transferred to the victim terminal by defining a new downlink control information (DCI) including contents for the desired signal to be transmitted to the victim terminal (i.e. a transmission using a single DCI). Alternatively, a separate DCI including the parameters which should be explicitly transferred to the victim terminal may be transmitted to the victim terminal, in addition to the DCI for the desired signal (i.e. a transmission using multiple DCIs).

(2) Methods of Estimating Channels for Other Cells and Transferring PMI-Related Information in a CRS Based Transmission Environment

Unlike the intra-cell interferences generated in a MU-MIMO transmission environment, when a CRS based transmission is assumed, transmission modes such as a transmit diversity (TM3), a spatial diversity (TM4), and a MU-MIMO (TM5) may be applied to the inter-cell interferences.

In order for the victim terminal to perform CRS-based channel estimation on inter-cell interference signals, the victim terminal should have parameters related to CRS generation, CRS resource allocation information, PMI allocation information, and frequency resource allocation information of interference signals related to the PMI allocation.

The parameters related to CRS generation may include cell ID information (N_{ID}^{CELL}), CP length information, and slot number information (nₛ). The CRS resource allocation information may include information of an antenna port and a cell ID. Generally, a victim cell and an interfering cell may use the same length of CP.

In case of CRS-based inter-cell interferences, PMI allocation information also should be transmitted to the victim terminal.

Since information on cell ID, slot number, and antenna port can obtained through a procedure of receiving PSS/SSS and PBCH within a single cell, the above information can be transferred to the terminal without additional resource allocation. That is, the terminal may obtain cell ID information and slot number information based on the received PSS/SSS, and antenna port information based on the received PBCH. However, in the inter-cell interference environment, even when the above information is transferred via a backhaul link from a base station of an interfering cell to a base station of a victim cell, the above-described parameters such T_{SLOT}, T_{CP}, etc. are needed to be transmitted to the victim terminal.

The antenna port information for antenna ports 0 to 3 is implicitly transmitted to a terminal by using a CRC masking on PBCH in the conventional intra-cell environment. Therefore, in order to transfer the CRS based antenna port information of the interfering cell to the victim terminal, additional signaling parameter should be defined in the inter-cell interference environment.

In the present invention, a parameter value (TAP) is allocated to each antenna port as shown in the following table 5, and the parameter value may be transferred to the victim terminal.

TABLE 5

| Antenna port number | TAP |
|---|---|
| 0 | 00 |
| 1 | 01 |
| 2 | 10 |
| 3 | 11 |

Meanwhile, in order for the victim terminal to perform CRS-based channel estimation on inter-cell interference signals, CRS resource allocation information is also necessary. However, since the CRS resource may also be determined according to the antenna port number and the cell ID, additional signaling overhead does not occur in connection with the CRS resource allocation information.

The frequency resource allocation information of interference signals related to the PMI allocation may be transferred to the victim terminal in the same manner as the above-described methods for intra-cell interference cases. That is, parameters for all interference signals may be explicitly transmitted to the victim terminal, or parameters only for one or more dominant interference signals may be transmitted to the victim terminal.

Similarly to the above-described methods for the DM-RS based interference signal cases, the CRS related information and PMI information of the inter-cell interference signals may be transmitted to the victim terminal via a single DCI or multiple DCIs.

While the example embodiments of the present invention and their advantages have been described in detail, it should be understood that various changes, substitutions and alterations may be made herein without departing from the scope of the invention.

What is claimed is:

1. A method for providing interference information, performed in a base station, the method comprising:
obtaining information about at least one intra-cell interference signal interfering desired signals of a victim terminal; and
transferring the information about at least one intra-cell interference signal to the victim terminal,
wherein the information about at least one intra-cell interference signal includes either information related to generation of reference signal for the at least one intra-cell interference signal or frequency resource allocation information and precoding matrix indicator (PMI) allocation information for the at least one intra-cell interference signal.

2. The method of claim 1, wherein, in the transferring the information about at least one intra-cell interference signal, when the at least one intra-cell interference signal is transmitted based on demodulation reference signal (DM-RS), the information about at least one intra-cell interference signal includes information related to generation of DM-RS, and the information related to generation of DM-RS is transmitted by using at least one value indicating at least one of combinations of antenna ports and scrambling identities which are used for generating the DM-RS of the at least one intra-cell interference signal.

3. The method of claim 2, wherein the combinations of antenna ports and scrambling identities include combinations of scrambling identities and antenna ports 7 and 8.

4. The method of claim 1, wherein, in the transferring the information about at least one intra-cell interference signal, when the at least one intra-cell interference signal is transmitted based on cell-specific reference signal (CRS), the information about intra-cell interference signals includes frequency resource allocation information and PMI allocation information for all intra-cell interference signals detected within a cell of the base station.

5. The method of claim 1, wherein, in the transferring the information about at least one intra-cell interference signal, when the at least one intra-cell interference signal is transmitted based on cell-specific reference signal (CRS), the information about intra-cell interference signals includes frequency resource allocation information and PMI allocation information for at least one dominant intra-interference signal selected among a plurality of multiple intra-cell interference signals according to predefined criteria.

6. The method of claim 5, wherein the frequency resource allocation information and PMI allocation information are transmitted to the victim terminal separately for each of the at least one dominant intra-interference signal, or transmitted to the victim terminal as an interference information map including frequency resource allocation information and PMI allocation information for the at least one dominant intra-interference signal.

7. The method of claim 6, wherein the interference information map comprises information on at least one sub-band allocated to each of the at least one dominant intra-interference signal and a PMI allocated to the at least one sub-band.

8. The method of claim 1, wherein, in the transferring the information about at least one intra-cell interference signal, the information about at least one intra-cell interference signal is transferred to the victim terminal as included in a single downlink control information (DCI) with information about the desired signals of the victim terminal, or is transferred to the victim terminal as a DCI separated from a DCI for the information about the desired signals of the victim terminal.

9. A method for providing interference information, performed in a base station, the method comprising:
obtaining information about at least one inter-cell interference signal interfering desired signals of a victim terminal; and
transferring the information about at least one inter-cell interference signal to the victim terminal,
wherein the information about at least one inter-cell interference signal includes at least one of information on generation of reference signal for the at least one inter-cell interference signal, resource allocation information of the reference signal, and resource allocation information of the at least one inter-cell interference signal.

10. The method of claim 9, wherein the information about at least one inter-cell interference signal is obtained from at least one other base station via at least one backhaul link.

11. The method of claim 9,
wherein, when the reference signal for the at least one inter-cell interference signal is a demodulation reference signal (DM-RS), the information on generation of reference signal includes at least one of antenna port information, slot number information, scrambling identity information, virtual cell identity information, and radio network temporary identifier information for the at least one inter-cell interference signal,
wherein, when the reference signal for the at least one inter-cell interference signal is a cell-specific reference signal (CRS), the information on generation of reference signal includes at least one of cell identity information, cyclic prefix length information, and slot number information for the at least one inter-cell interference signal.

12. The method of claim 11, wherein the slot number information is transmitted as a parameter corresponding to the slot number.

13. The method of claim 9, wherein the resource allocation information of the reference signal includes at least one of mapping pattern information and frequency shift information for the at least one inter-cell interference signal when the reference signal is a DM-RS, and the resource allocation information of the reference signal includes at least one of antenna port information and cell identity information for the at least one inter-cell interference signal when the reference signal is a CRS.

14. The method of claim 9, wherein, in the transferring the information about at least one inter-cell interference signal to the victim terminal, the information on generation of reference signal for only at least one inter-cell interference signal interfering a frequency resource block allocated to the victim terminal and resource allocation information of the reference signal is transferred to the victim terminal.

15. The method of claim 9, wherein, in the transferring the information about at least one inter-cell interference signal to the victim terminal, when an antenna port 5 is applied to the at least one inter-cell interference signal, cell identity information and cyclic prefix length information for the at least one inter-cell interference signal are transferred to the victim terminal.

16. The method of claim 9, wherein, in the transferring the information about at least one inter-cell interference signal to the victim terminal, when at least one of antenna ports 7 to 14 is applied to the at least one inter-cell interference signal, antenna port information, scrambling identity information, cell identity information, and slot number information for the at least one inter-cell interference signal are transferred to the victim terminal.

17. The method of claim 16, wherein, in the transferring the information about at least one inter-cell interference signal to the victim terminal, combinations of antenna ports or combinations of antenna ports and scrambling identities are configured, and at least one value indicating at least one of the combinations corresponding to the at least one inter-cell interference signal is transmitted to the victim terminal.

18. The method of claim 16, wherein, in the transferring the information about at least one inter-cell interference signal to the victim terminal, the combinations of antenna ports and scrambling identities are configured as a specific number of combinations in consideration of DM-RS mapping patterns according to antenna ports, each of the combinations having a corresponding indication value, and at least one indication value corresponding to DM-RS mapping pattern of the at least one inter-cell interference signal is transmitted to the victim terminal.

19. The method of claim 16, wherein, in the transferring the information about at least one inter-cell interference signal to the victim terminal, when the at least one inter-cell interference signal is transmitted based on CRS, the information about at least one inter-cell interference signal includes CRS generation information, CRS resource allocation information, PMI allocation information, and resource allocation information for the at least one inter-cell interference signal.

20. The method of claim 16, wherein, in the transferring the information about at least one inter-cell interference signal to the victim terminal, when the at least one inter-cell interference signal is transmitted based on CRS, the information about at least one inter-cell interference signal includes at least one parameter value corresponding to at least one antenna port for the at least one inter-cell interference signal.
